(19) United States
(12) Patent Application Publication
(10) Pub. No.: US 2021/0102652 A1
(43) Pub. Date: Apr. 8, 2021

(54) DOUBLE PIPE

(71) Applicant: YUTAKA GIKEN CO., LTD., Hamamatsu-shi (JP)

(72) Inventors: Koji Yamamoto, Hamamatsu-shi (JP); Akihiro Kawamata, Hamamatsu-shi (JP); Takashi Wagatsuma, Hamamatsu-shi (JP)

(21) Appl. No.: 17/039,276

(22) Filed: Sep. 30, 2020

(30) Foreign Application Priority Data
Oct. 8, 2019 (JP) 2019-184906

(51) Int. Cl. F16L 39/00; F16L 43/00; F28D 7/10; F28D 7/14

(52) U.S. Cl. CPC F16L 39/005; F28D 7/14; F28D 7/106; F16L 43/00

(57) ABSTRACT

At least two spacers in an elongated shape is provided between an internal pipe and an external pipe along the center line of a double pipe. In the cross section of a bent portion as viewed in a direction along the center line of the double pipe, the first spacer is located inwardly relative to the center of the double pipe with reference to the radial direction of the bent portion. The second spacer is located outwardly relative to the center of the double pipe. When a straight line that passes through the center of the radius of the bent portion and through the center of the double pipe is taken as a reference line at least either one of the first spacer or the second spacer overlaps the reference line.

### FIELD OF THE INVENTION

The present disclosure relates to a double pipe which includes a bent portion, and which is formed by an internal pipe and an external pipe, and a manufacturing method of the same.

### BACKGROUND

Some double pipes each formed by an internal pipe and an external pipe have a bent portion formed by bending. Patent Document 1 discloses a conventional technology relating to a double pipe that includes such a bent portion.

FIG. 15 corresponds to FIG. 1A of Patent Document 1, but has reassigned reference numerals for the purpose of explanation. A double pipe 100 includes an internal pipe 110, an external pipe 120 in which the internal pipe 110 is inserted, and a plurality of spherical spacers 130 placed between the internal pipe 110 and the external pipe 120. The respective spacers 130 are placed at an appropriate pitch in the circumferential direction. Moreover, the respective spacers 130 are placed at an appropriate pitch in a direction along the axis (the center line) of the double pipe. The double pipe 100 is formed in a U-shape, and includes straight pipe portions 140 and 140 elongated in parallel with each other, and a bent portion 150 located between respective ends of the straight pipe portions 140 and 140.

An example manufacturing method of the double pipe 100 that includes the bent portion 150 will be described. First of all, the internal pipe 110, the external pipe 120 in which the internal pipe 110 can be inserted, and the plurality of spacers 130 that can be placed between the internal pipe 110 and the external pipe 120 are prepared. Next, the spacers 130 are welded to the outer circumference of the internal pipe 110. Subsequently, the internal pipe 110 to which the spacers 130 are attached is inserted in the external pipe 120, thereby obtaining a linear double pipe. Eventually, the double pipe is bent by a pipe bender, etc,. Accordingly, the double pipe 100 that includes the bent portion 150 is obtained.

Patent Document 1: JP 2009-241145 A

### SUMMARY OF THE INVENTION

The spacers 130 are provided between the internal pipe 110 and the external pipe 120. Hence, when the external pipe 120 is bent, the internal pipe 110 can be also bent along the inner circumference of the external pipe 120, but it is desirable to further precisely bend the internal pipe 110.

An objective of the present disclosure is to provide a technology capable of precisely bending a double pipe.

A double pipe with a bent portion according to a first embodiment of the present disclosure is the double pipe including an internal pipe and an external pipe,

in which at least two spacers in an elongated shape are provided between the internal pipe and the external pipe along a center line of the double pipe,

in which, in a cross section of the bent portion as viewed in a direction along the center line of the double pipe, the first spacer in at least the two spacers is located inwardly relative to a center of the double pipe and the second spacer is located outwardly relative to the center of the double pipe with reference to a radial direction of the bent portion, and

in which, with a straight line that passes through a center of a radius of the bent portion and through the center of the double pipe being defined as a reference line, at least either one of the first spacer or the second spacer overlaps the reference line.

According to a second embodiment of the present disclosure, a heat transfer pipe through which a fluid with a different temperature than a temperature of a fluid flowing through the internal pipe flows abuts an outer circumference of the external pipe.

According to a third embodiment of the present disclosure, the heat transfer pipe is placed so as to hold the external pipe with either one of at least the two spacers.

A manufacturing method of a double pipe according to a fourth embodiment of the present disclosure includes:

a preparation step of preparing a first pipe, a second pipe to be inserted in the first pipe, and at least two spacers in an elongated shape to be placed between the first pipe and the second pipe;

a placing step of placing the second pipe and at least the two spacers in the first pipe in such a way that either one of at least the two spacers overlaps a reference surface covering a center line of the second pipe to obtain a double straight pipe; and

a bending step of bending the double straight pipe along the reference surface.

A double pipe with a bent portion according to a fifth embodiment of the present disclosure is the double pipe including an internal pipe and an external pipe,

in which a spacer that comprises an elongated portion in an elongated shape and placed along a center line of the double pipe is provided between the internal pipe and the external pipe, the spacer comprising a plurality of extended portions extended from the elongated portion in a circumferential direction of the double pipe, and

in which, with a straight line passing through the elongated portion and through a center of the double pipe being defined as a reference line, the respective extended portions are extended beyond the reference line when a cross section of the bent portion is viewed in a direction along the center line.

According to a sixth embodiment of the present disclosure, a heat transfer pipe through which a fluid with a different temperature than a temperature of a fluid flowing through the internal pipe flows abuts an outer circumference of the external pipe.

According to a seventh embodiment of the present disclosure, the heat transfer pipe is placed so as to hold the external pipe with the elongated portion.

A manufacturing method of a double pipe according to an eighth embodiment of the present disclosure includes:

a preparation step of preparing a first pipe, a second pipe to be inserted in the first pipe, and a spacer that comprises an elongated portion in an elongated shape, and a plurality of extended portions extended horizontally from a side face of the elongated portion in a lengthwise direction;

a spacer bending step of curving each of the plurality of extended portions of the spacer to obtain a curved spacer;

a placing step of placing the second pipe and the curved spacer in the first pipe with the elongated portion of the curved spacer being aligned with a center line of the second pipe to obtain a double straight pipe that has each of the plurality of extended portions extended beyond a reference line as viewed in a direction along the center line, the reference line being a straight line passing through the elongated portion and a center of the second pipe; and

a straight pipe bending step of bending the double straight pipe.

According to the above first embodiment, at least two spacers in an elongated shape are provided between the internal pipe and the external pipe along the center line of the double pipe. The first spacer in at least the two spacers is located inwardly relative to the center of the double pipe and the second spacer is located outwardly relative to the center of the double pipe with reference to the radial direction of the bent portion.

A straight line that passes through the center of a radius of the bent portion and through the center of the double pipe will be defined as a reference line. The portions of the bent portion overlapping the reference line are portions that are deformed maximally in bending. At least either one of the first spacer or the second spacer overlaps the reference line.

That is, at least either one of the first spacer or the second spacer is provided on a portion of the double pipe compressed maximally or a portion thereof drawn maximally in the circumferential direction.

Since both the spacers are formed in an elongated shape, those spacers can be provided in an arcuate shape that is continuous from the first end of the bent portion to the second end thereof. Accordingly, when the double pipe is bent to form the bent portion, the internal pipe can be bent along the first spacer or the second spacer. This enables the double pipe to be precisely bent.

According to the above second embodiment, a heat transfer pipe through which a fluid with a different temperature than that of a fluid flowing through the internal pipe flows abuts the outer circumference of the external pipe. Hence, the fluid that flows through the heat transfer pipe becomes a medium to heat or cool the fluid flowing through the internal pipe.

According to the above third embodiment, the heat transfer pipe is placed so as to hold the external pipe with either one of at least the two spacers. The external pipe is a heat transfer path between the spacer and the heat transfer pipe. Since the distance of such a path can be reduced, the fluid flowing through the internal pipe can be further efficiently heated or cooled.

According to the above fourth embodiment, in the placing step of a double pipe manufacturing method, the second pipe and the two spacers are placed in the first pipe in such a way that the two spacers overlap a reference surface covering center line of the second pipe. In the bending step, the double straight pipe is bent along the reference surface. Portions of the first straight pipe and of the second straight pipe which overlap the reference surface are portions compressed maximally, and portions drawn maximally. The spacer is placed between either types of such portions. This enables the double pipe to be precisely bent in the bending step.

According to the above fifth embodiment, a spacer that includes an elongated portion in an elongated shape and placed along the center line of the double pipe is provided between the internal pipe and the external pipe. The spacer includes a plurality of extended portions extended from the elongated portion in the circumferential direction of the double pipe. With a straight line passing through the elongated portion and through the center of the double pipe being defined as a reference line, the respective extended portions are extended beyond the reference line when a cross section of the bent portion is viewed in a direction along the center line.

That is, when the cross section of the bent portion is viewed in the direction along the center line, the half of the annular space between the internal pipe and the external pipe is filled by the arcuate spacer.

Accordingly, a portion of the arcuate spacer is located on at least either one of a portion of the double pipe compressed maximally or a portion thereof drawn maximally. Hence, when the double pipe is bent, the internal pipe can be bent along the spacer. This enables the double pipe to be precisely bent.

In addition, the elongated portion and the extended portions are formed integrally with each other as a singular component. Hence, when either one of the elongated portion or the extended portions are placed at the predetermined location within the external pipe, the other portion is inevitably placed at the predetermined location. In comparison with a case in which a plurality of spacers is individually placed at each predetermined position, positioning of the spacer is facilitated.

According to the above sixth embodiment, a heat transfer pipe through which a fluid with a different temperature than that of a fluid flowing through the internal pipe flows abuts the outer circumference of the external pipe. Hence, the fluid that flows through the heat transfer pipe becomes a medium to heat or cool the fluid flowing through the internal pipe.

According to the above seventh embodiment, the heat transfer pipe is placed so as to hold the external pipe with the elongated portion. The external pipe is a heat transfer path between the spacer and the heat transfer pipe. Since the distance of such a path can be reduced, the fluid flowing through the internal pipe can be further efficiently heated or cooled.

According to the above eighth embodiment, in the preparation step of a double pipe manufacturing method, a first pipe, a second pipe to be inserted in the first pipe, and a spacer that includes an elongated portion in an elongated shape, and a plurality of extended portions extended horizontally from a side face of the elongated portion in a lengthwise direction are prepared. In the spacer bending step, each of the plurality of extended portions of the spacer are curved to obtain a curved spacer. In the placing step of placing the second pipe and the curved spacer in the first pipe, with the elongated portion of the curved spacer being aligned with the center line of the second pipe the second pipe and the curved spacer are placed in the first pipe. Hence, a double straight pipe that has each of the plurality of extended portions extended beyond a reference line as viewed in a direction along the center line. The reference line is a straight line passing through the elongated portion and the center of the second pipe.

According to this double straight pipe, the half of the annular space between the internal pipe and the external pipe is filled by the arcuate spacer. A portion of the arcuate spacer is placed on at least either one of a portion of the double pipe to be compressed maximally or a portion thereof to be drawn maximally. Hence, in the straight pipe bending step, the internal pipe can be bent along the portion of the spacer. This enables the double pipe to be precisely bent.

### BRIEF DESCRIPTION OF THE DRAWINGS

FIG. 1A is a plan view of a pipe composite assembly including a double pipe according to a first preferable embodiment, and FIG. 1B is a cross-sectional view taken along a line 1B-1B in FIG. 1A;

FIG. 2A is a diagram for describing a preparation step in a double pipe manufacturing method illustrated in FIG. 1A, FIG. 2B is a diagram for describing an internal pipe to which spacers are attached, and FIG. 2C is a diagram as viewed along an arrow 2C in FIG. 2B.

FIG. 3A to FIG. 3C are each a diagram for describing a placing step of obtaining a double straight pipe;

FIG. 4A and FIG. 4B are each a diagram for describing a bending step of obtaining a double pipe that includes a bent portion;

FIG. 5A is a perspective view of a double pipe according to a second preferable embodiment, and FIG. 5B is a diagram as viewed along an arrow 5B in FIG. 5A;

FIG. 6A is a diagram for describing a preparation step in a double pipe manufacturing method illustrated in FIG. 5A, and FIG. 6B is a diagram for describing a spacer illustrated in FIG. 5A;

FIG. 7A is a diagram for describing a spacer bending step of obtaining a curved spacer, and FIG. 7B and FIG. 7C are diagrams for describing steps of obtaining a pipe with a spacer;

FIG. 8A and FIG. 8B are diagrams for describing a placement step of obtaining a double straight pipe, and FIG. 8C is a diagram as viewed along an arrow 8C in FIG. 8B;

FIG. 9A and FIG. 9B are diagrams for describing a bending step of obtaining a double pipe that includes a bent portion;

FIG. 10A is a diagram for describing the bent portion as viewed in a direction along the center of a radius of the bent portion, and FIG. 10B is a cross-sectional view taken along a line 10B-10B in FIG. 10A;

FIG. 11A is a perspective view of a double pipe according to a third preferable embodiment, and FIG. 11B is a cross-sectional view taken along a line 11B-11B in FIG. 11A.

FIG. 12A is a diagram for describing a preparation step in a double pipe manufacturing method illustrated in FIG. 11A, and FIG. 12B is a diagram as viewed along an arrow 12B in FIG. 12A.

FIG. 13A is a diagram for describing a spacer bending step of obtaining an annular spacer, and FIG. 13B to FIG. 13D are each a diagram for describing a placement step of inserting a pipe with the spacer in an external pipe;

FIG. 14A is a diagram for describing a bending step of bending a double straight pipe, FIG. 14B is a cross-sectional view taken along a line 14B-14B in FIG. 14A, and FIG. 14C is a cross-sectional view taken along a line 14C-14C in FIG. 14C; and

FIG. 15 is a diagram for describing a basic structure of a conventional technology.

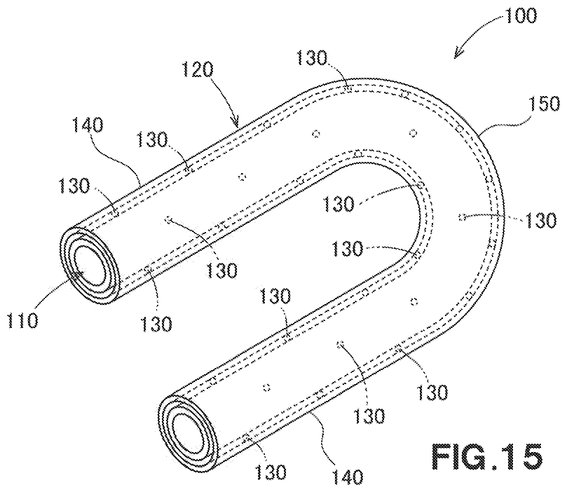

### DETAILED DESCRIPTION OF THE PREFERABLE EMBODIMENTS

Preferable embodiments of the present disclosure will be described below with reference to the accompanying figures.

### First Preferable Embodiment

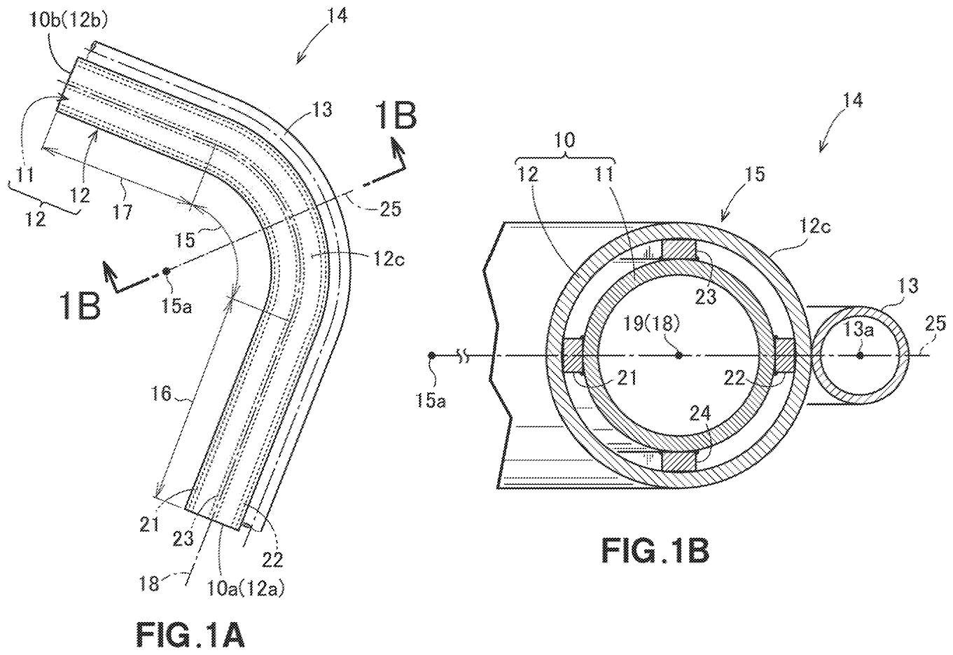

FIGS. 1A and 1B illustrate a pipe composite assembly 14 that includes a double pipe 10 formed by an internal pipe 11 and an external pipe 12, and a singular pipe 13 placed along the double pipe 10.

The double pipe 10 includes the internal pipe 11 having an interior through which a first fluid can flow, the external pipe 12 in which the internal pipe 11 is inserted, and four spacers 21 to 24 placed between the internal pipe 11 and the external pipe 12.

The double pipe 10 includes a bent portion 15 having undergone bending, a first straight pipe portion 16 at a first end of the bent portion 15, and a second straight pipe portion 17 at a second end of the bent portion 15.

The first spacer 21 to the fourth spacer 24 are each in an elongated shape, and are provided continuously from a first end 10a of the double pipe 10 to a second end 10b thereof. Note that it is adequate if the first spacer 21 to the fourth spacer 24 are placed at least along the bent portion 15, and such spacers may be not placed on the first straight pipe portion 16 and on the second straight pipe portion 17. The first spacer 21 to the fourth spacer 24 are aligned along a center line 18 of the double pipe 10. Note that the center line 18 of the double pipe 10, the center line of the internal pipe 11, and the center line of the external pipe 12 are consisted with each other.

In the cross section (see FIG. 1B) of the bent portion 15 as viewed in a direction along the center line 18 of the double pipe 10, the first spacer 21 to the fourth spacer 24 are respectively placed at an equal pitch in the circumferential direction relative to each other. The respective cross sections of the first spacer 21 to the fourth spacer 24 are all rectangular.

With reference to the radial direction of the bent portion 15, the first spacer 21 is located inwardly relative to a center 19 of the double pipe 10. The second spacer 22 is located outwardly relative to the center 19 of the double pipe 10.

A straight line that passes through a center 15a of the radius of the bent portion 15 and through the center 19 of the double pipe 10 will be defined as a reference line 25. The first spacer 21 and the second spacer 22 overlap the reference line 25. Note that a structure in which at least either one of the first spacer 21 or the second spacer 22 overlap the reference line 25 may be employed. That is, the spacers other than the spacers overlapping the reference line 25 may be placed as appropriate in the circumferential direction of the double pipe 10. Moreover, the respective cross sections of the first spacer 21 to the fourth spacer 24 may be in an arbitrary shape.

The singular pipe 13 (a heat transfer pipe 13) abuts an outer circumference 12c of the external pipe 12 from a first end 12a of the external pipe 12 to a second end 12b thereof. More specifically, the singular pipe 13 is placed so as to hold that the external pipe 12 with the second spacer 22. A center 13a of the singular pipe 13 is located on the reference line 25.

Note that although the singular pipe 13 is held by brazing etc., on an unillustrated holding plate relative to the external pipe 12, other conventional technologies are applicable. A second fluid with a higher temperature than that of the first fluid can flow through the interior of the singular pipe 13.

A manufacturing method of the double pipe 10 that includes the bent portion 15 will be described.

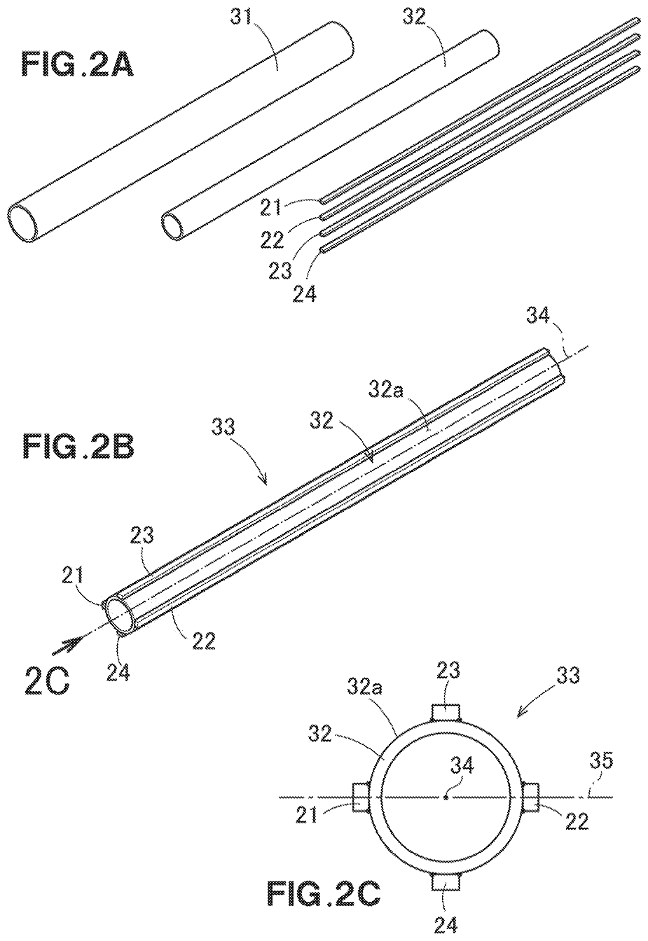

With reference to FIG. 2A, first, a first pipe 31 extended straightly, a second pipe 32 which is extended straightly and which can be inserted in the first pipe 31, and the first spacer 21 to the fourth spacer 24 which are each in an elongated shape and which can be placed between the first pipe 31 and the second pipe 32 are prepared (a preparation step).

With reference to FIG. 2B, next, the first spacer 21 to the fourth spacer 24 are joined to an outer circumference 32a of the second pipe 32 to obtain the pipe 33 with the spacers.

With reference to FIG. 2B and FIG. 2C, as an example joining scheme, the spacers 21 to 24 are tentatively fastened to the outer circumference 32a by TIG welding.

The first spacer 21 to the fourth spacer 24 are placed so as to have an equal pitch in the circumferential direction of the second pipe 32 relative to each other. As viewed in a direction from the first end of the second pipe 32 to the second end thereof, a surface which covers a center line 34 of the second pipe 32, and on which the first spacer 21 and the second spacer 22 overlap with each other will be defined as a reference surface 35. Note that the third spacer 23 and fourth spacer 24 may be placed at appropriate locations in the circumferential direction.

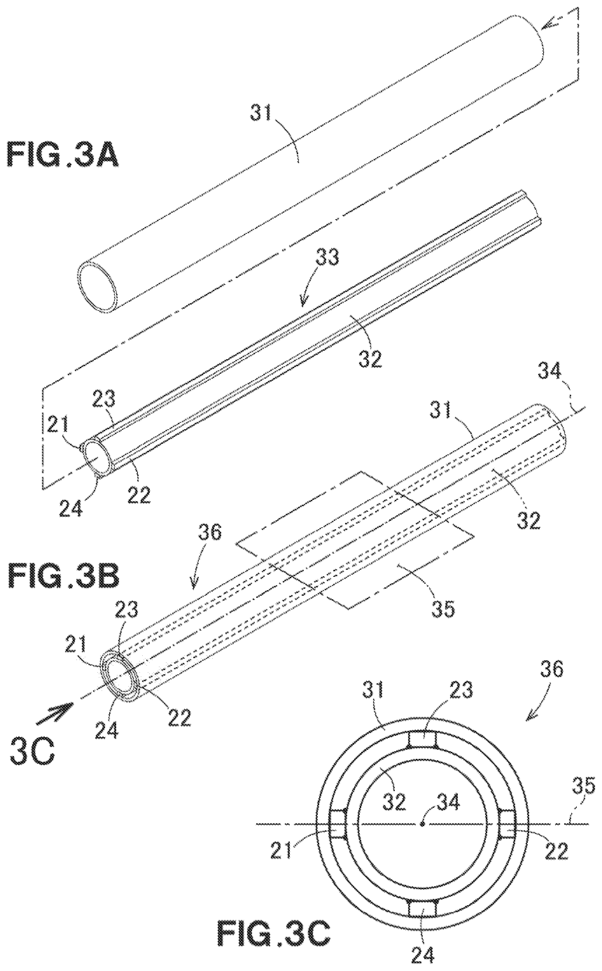

With reference to FIG. 3A and FIG. 3B, next, the pipe 33 with the spacers are inserted in the first pipe 31 to obtain a double straight pipe 36 (a placing step).

With reference to FIG. 3C, the first spacer 21 to the fourth spacer 24 are placed at an equal pitch in the circumferential direction relative to each other between the internal pipe 11 and the external pipe 12. The center line 34 of the second pipe 32, the center line of the double straight pipe 36, and the center line of the first pipe 31 are consistent with each other, and these lines are within the reference surface 35.

Note that after the second pipe 32 is inserted in the first pipe 31, the first spacer 21 to the fourth spacer 24 may be placed between the first pipe 31 and the second pipe 32.

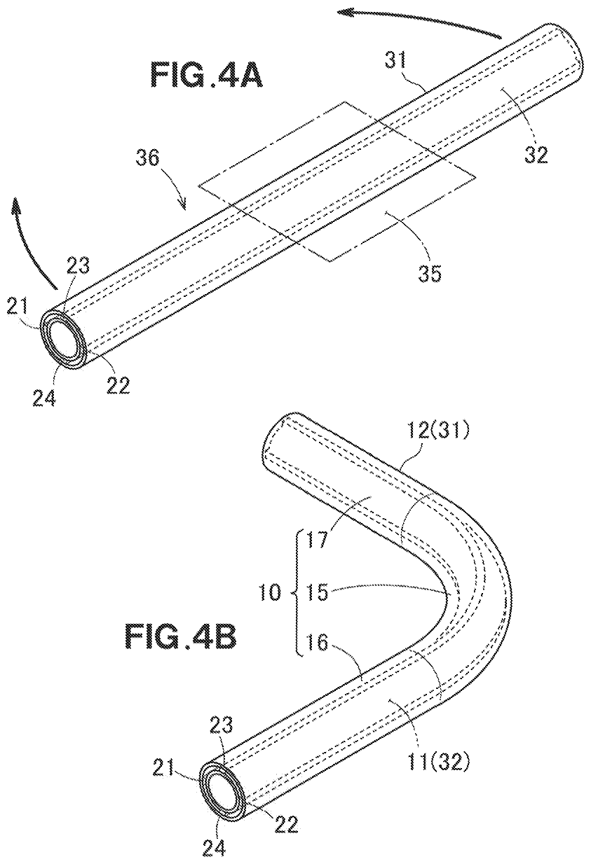

With reference to FIG. 3C and FIG. 4A, next, the double straight pipe 36 is bent in the direction along the reference surface 35, i.e., in such a way that the first spacer 21 and the second spacer 22 are not out of the reference surface 35 (a bending step). Through the above steps, the double pipe 10 that includes the bent portion 15 as illustrated in FIG. 4B is obtained.

Note that in the above-described placing step, the reference surface 35 may be a surface which covers the center line 34 of the second pipe 32, and which overlaps either one of the first spacer 21 or the second spacer 22.

Advantageous effects according to the first preferable embodiment will be described below.

With reference to FIGS. 1A and 1B, provided between the internal pipe 11 and the external pipe 12 are the four spacers 21 to 24 in an elongated shape along the center line of the bent portion 15. With reference to the radial direction of the bent portion 15, the first spacer 21 is located inwardly relative to the center 19 of the double pipe 10. The second spacer 22 is located outwardly relative to the center 19 of the double pipe 10. Furthermore, the first spacer 21 and the second spacer 22 overlap the reference line 25.

That is, the first spacer 21 is provided between a portion of the internal pipe 11 which is compressed maximally, and a portion of the external pipe 12 which is compressed maximally. The second spacer 22 is provided between a portion of the internal pipe 11 which is drawn maximally, and a portion of the external pipe 12 which is drawn maximally. Since the spacers 21 and 22 are in an elongated shape, those are continuously provided from the first end of the bent portion 15 to the second end thereof. Hence, when the double pipe 10 is bent and the bent portion 15 is formed, the internal pipe 11 can be bent along the first spacer 21 and along the second spacer 22. This enables the double straight pipe 36 (see FIG. 4A) to be precisely bent.

In addition, the singular pipe 13 through which the second fluid that has a higher temperature than that of the first fluid can flow abuts the outer circumference 12c of the external pipe 12. Accordingly, the second fluid can be a medium that heats the first fluid flowing through the internal pipe 11.

Moreover, the singular pipe 13 is placed so as to hold the external pipe 12 together with the second spacer 22. The external pipe 12 is a heat transfer path that transfers heat between the second spacer 22 and the singular pipe 13. Placement so as to be held reduces the length of the heat transfer path. Accordingly, the first fluid flowing through the internal pipe 11 can be further efficiently heated. Note that, instead of the second spacer 22, the external pipe 12 may be held between any of the spacers 21, 23, and 24, and, the singular pipe 13.

When the second fluid that has a lower temperature than that of the first fluid is caused to flow inside the singular pipe 13, the first fluid can be cooled.

With reference to FIG. 3B and 3C, in the placing step of the manufacturing method for the double pipe 10, the first spacer 21 and the second spacer 22 are placed to the exterior of the second pipe 32 in such a way that the two elongated spacers 21 and 22 in an elongated shape overlap the reference surface 35 covering the center line 34 of the second pipe 32.

With reference to FIG. 4A and FIG. 4B, in the bending step, the double pipe 10 is bent in the direction along the reference surface. Hence, portions of the first pipe 31 and the second pipe 32 which overlap the reference surface 35 become the portion compressed maximally, and the portion drawn maximally. The first spacer 21 and the second spacer 22 are placed between these portions. Consequently, in the bending step, the double straight pipe 36 can be precisely bent.

### Second Preferable Embodiment

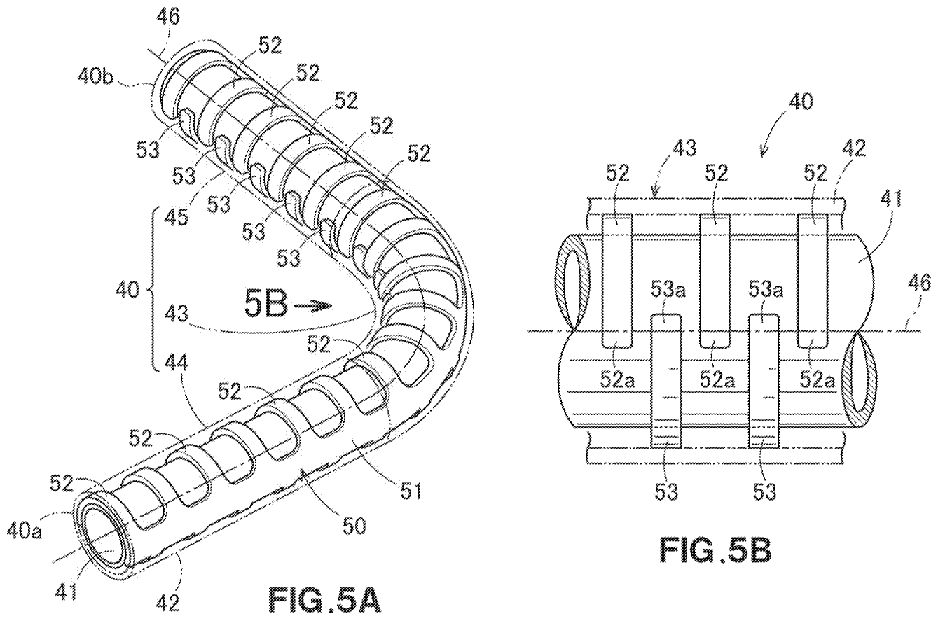

With reference to FIG. 5A, a double pipe 40 includes an internal pipe 41 through which the first fluid can flow, an external pipe 42 in which the internal pipe 41 is inserted, and a spacer 50 placed between the internal pipe 41 and the external pipe 42.

The double pipe 40 includes a bent portion 43 having undergone bending, a first straight pipe portion 44 extended straightly from the first end of the bent portion 43, and a second straight pipe portion 45 extended straightly from the second end of the bent portion 43.

With reference to FIG. 5A and FIG. 5B, the spacer 50 includes an elongated portion 51 in an elongated shape along a center line 46 of the double pipe 40 from a first end 40a of the double pipe 40 to a second end 40b thereof, and a plurality of extended portions 52 and 53 in the circumferential direction of the double pipe 40 from the elongated portion 51. Note that it is sufficient if the spacer 50 is placed along at least the bent portion 43, and such a spacer may not be placed on the first straight pipe portion 44 and on the second straight pipe portion 45.

Next, a manufacturing method of the double pipe 40 that includes the bent portion 43 will be described.

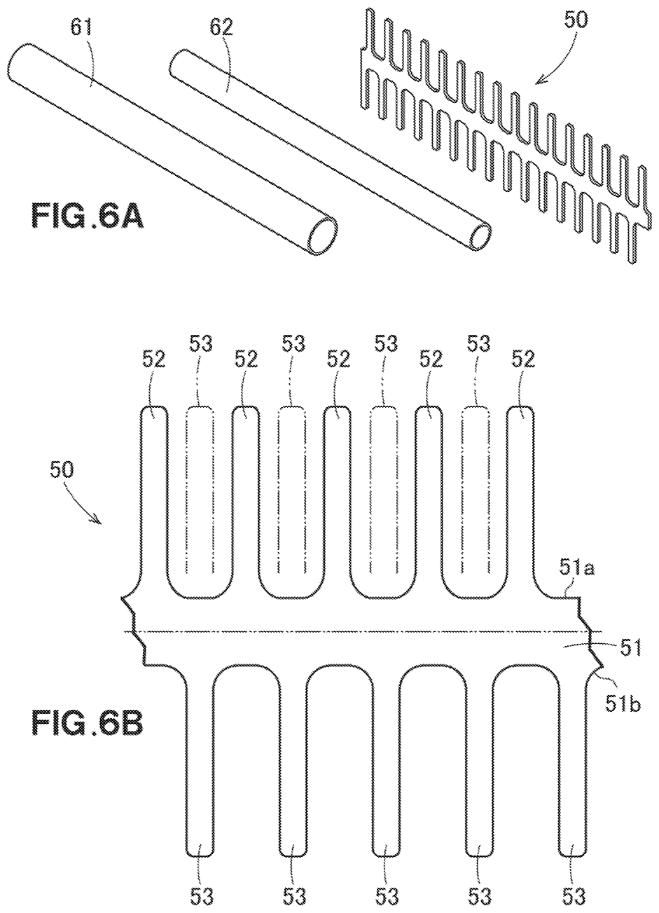

With reference to FIG. 6A, first, a first pipe 61 extended straightly, a second pipe 62 which is extended straightly and which can be inserted in the first pipe 61, and the spacer 50 are prepared (a preparation step).

With reference to FIG. 6B, the spacer 50 that is spread on a plane has the elongated portion 51 in an elongated shape, the plurality of first extended portions 52 extended from a one side face 51a of the elongated portion 51 in the lengthwise direction, and the plurality of second extended portions 53 extended from another side face 51b, and those are formed integrally with each other. Note that the spacer 50 may include only the first extended portions 52, or only the second extended portions 53. Moreover, the extending length of the first extended portion 52 and that of the second extended portion 53 may differ from each other.

The respective first extended portions 52 are orthogonal to the lengthwise direction of the elongated portion 51. The respective second extended portion 53 are orthogonal to the lengthwise direction of the elongated portion 51. The respective first extended portion 52 and the respective second extended portion 53 are placed alternately from each other along the elongated portion 51. More specifically, with reference to the line of the elongated portion 51 in the lengthwise direction, when folded toward the elongated portion 51, each first extended portion 52 and each second extended portion 53 are placed so as not to overlap with each other.

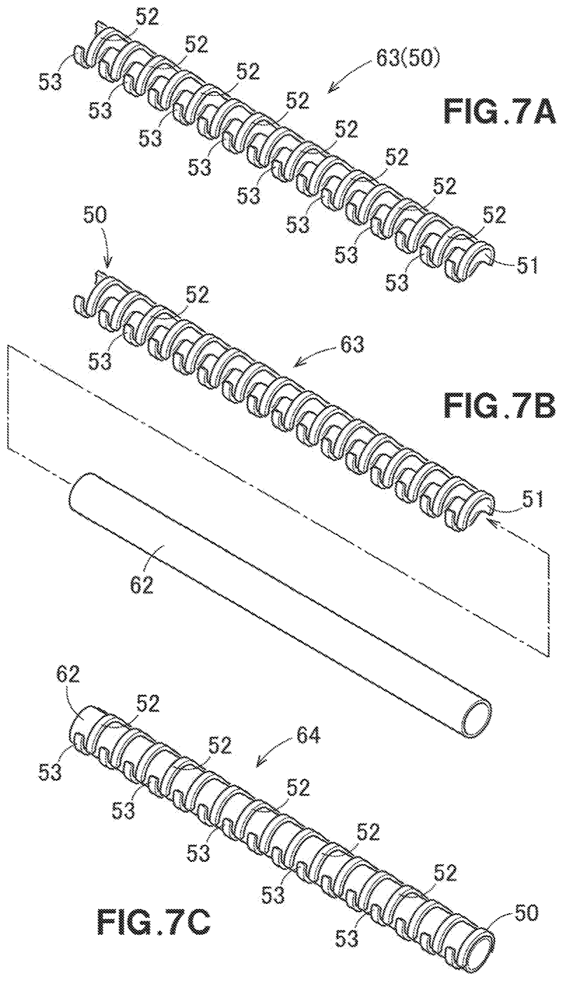

With reference to FIG. 7S, next, the spacer 50 is bent in a U-shape and in an O-shape using jigs, and the respective first extended portions 52 and the respective second extended portions 53 are bent and curved so as to come close to each other, thereby obtaining a curved spacer 63 (a spacer bending step).

With reference to FIG. 7B and FIG. 7C, next, the second pipe 62 is inserted in a cylindrical region defined by the first extended portions 52, the second extended portions 53, and the elongated portion 51, and tentative fastening is performed to obtain the pipe 64 with the spacer.

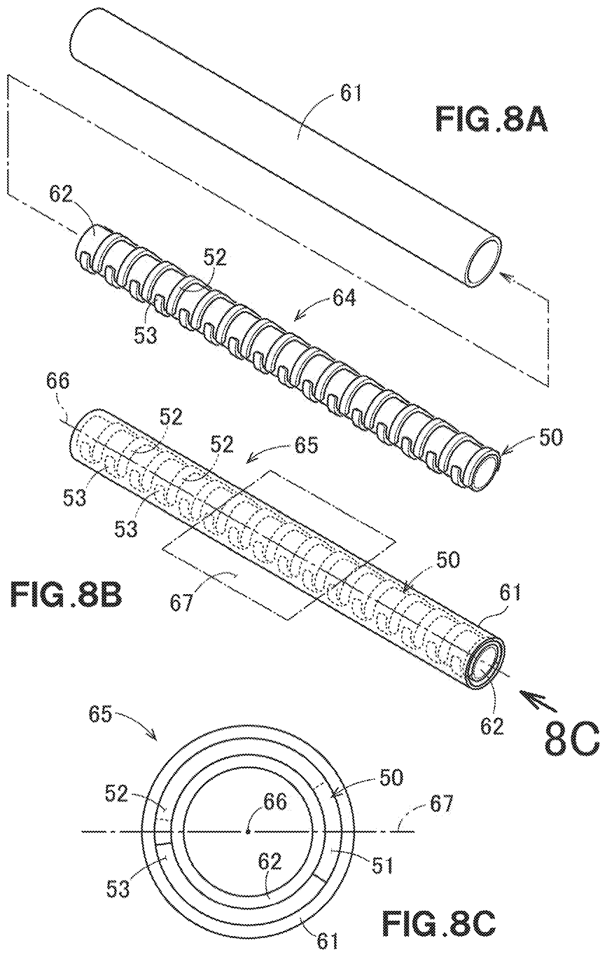

With reference to FIG. 8A and FIG. 8B, next, the pipe 64 with the spacer is inserted in the first pipe 61 to obtain a double straight pipe 65 (a placing step). With reference to FIG. 8C, a plane which covers the center line 66 of the double straight pipe 65, and on which the elongated portion 51 and the extended portions 52 and 53 overlap will be defined as a reference surface 67.

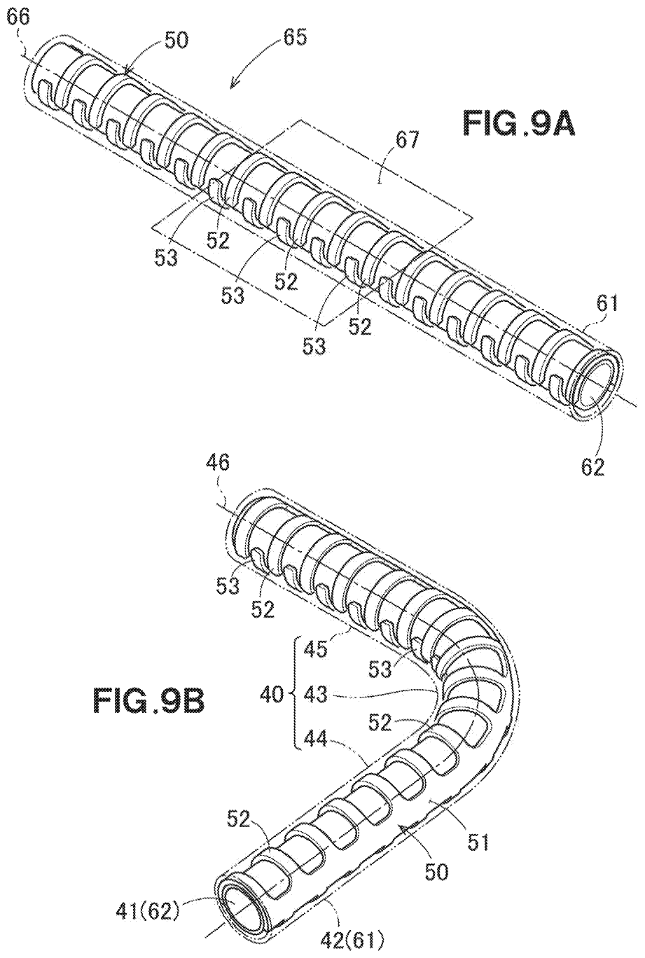

With reference to FIG. 9A, next, the double straight pipe 65 is bent in such a way that the adjoining first extended portion 52 and second extended portion 53 become close to each other along the reference surface 67 (a straight pipe bending step).

With reference to FIG. 9B, through the above steps, the double pipe 40 that includes the bent portion 43 is obtained. Note that, in the straight pipe bending step, the double straight pipe 65 may be bent in such a way that the adjoining first extended portion 52 and second extended portion 53 become apart from each other.

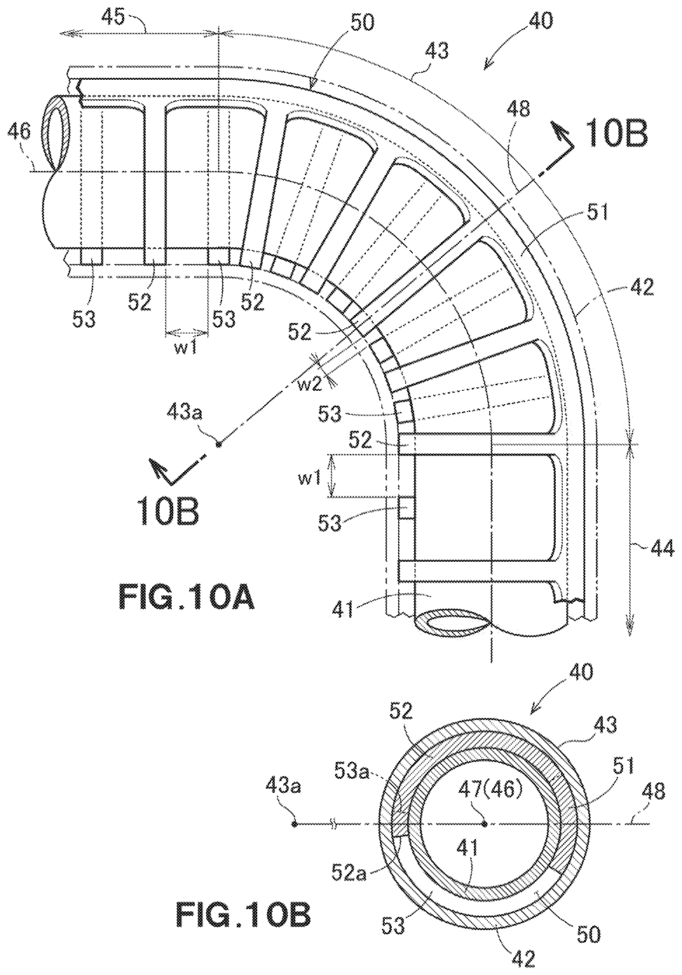

With reference to FIG. 10A and FIG. 10B, in the cross section of the bent portion 43 as viewed in the direction along the center line 46 of the double pipe 40 (see FIG. 10B), a straight line which passes through a center 43a of the radius of the bent portion 43, and through a center 47 of the double pipe 40 will be defined as a reference line 48. The elongated portion 51 is located outwardly in the radial direction relative to the center 47 of the double pipe 40, and overlaps the reference line 48.

With reference to FIG. 5B and FIG. 10B, a tip 52a of each first extended portion 52 is extended beyond the reference line 48. A tip 53a of each second extended portion 53 is extended beyond the reference line 48. When the cross section of the bent portion 43 is viewed in the direction along the center line 46, a space between the internal pipe 41 and the external pipe 42 is filled by the elongated portion 51 and the extended portions 52 and 53 across the entire circumference. As far as at least a half of the annular space between the internal pipe 41 and the external pipe 42 is filled by the spacer, the type of the spacer is not limited to any particular type. For example, either one of the extended portions 52 or 53 may not be extended beyond the reference line 48. Moreover, an arcuate spacer without the extended portions 53 may be applied. In the case of such a spacer, the elongated portion 51, the center 47 of the double pipe 40, and the extended portions 52 are located on the same straight line.

With reference to FIG. 10A, a pitch between the first extended portion 52 and the second extended portion 53 located on the first straight pipe portion 44 or on the second straight pipe portion 45 will be defined as W1. A pitch between the first extended portion 52 and the second extended portion 53 located on the bent portion 43 will be defined as W2. The pitch W2 is narrower than the pitch W1 (i.e., W2<W1).

Advantageous effects of the second preferable embodiment will be described below.

With reference to FIG. 5A and FIG. 5B, provided between the internal pipe 41 and the external pipe 42 is the spacer 50 that includes the elongated portion 51 in an elongated shape placed along the center line 46 of the double pipe 40. This spacer 50 includes the plurality of first extended portions 52 and the plurality of second extended portions 53 which are extended in the circumferential direction of the double pipe 40 from the elongated portion 51.

With reference to FIG. 10A and FIG. 10B, a portion of the bent portion 43 which overlaps the reference line 48 is a portion that is deformed maximally in bending. The elongated portion 51 overlaps the reference line 48. With reference to the radial direction of the bent portion 43, the elongated portion 51 is located outwardly relative to the center 47 of the double pipe 40. The respective tips 52a of the first extended portions 52 and the respective tips 53a of the second extended portions 53 are extended beyond the reference line 48.

That is, the respective tips 52a of the first extended portions 52 and the respective tips 53a of the second extended portions 53 are provided between the portion of the internal pipe 41 compressed maximally, and the portion of the external pipe 42 compressed maximally. The elongated portion 51 is provided between the portion of the internal pipe 41 drawn maximally, and the portion of the external pipe 42 drawn maximally. Hence, when the double pipe 40 is bent and the bent portion 43 is formed, the internal pipe 41 can be bent along the elongated portion 51 and the respective tips 52a and 53a. This enables a precise bending of the double pipe 40.

In addition, the elongated portion 51 and the extended portions 52 and 53 are formed integrally with each other. Hence, when either one of the elongated portion 51 or the extended portions 52 and 53 are placed at a predetermined location within the external pipe 42, the other portion is also and inevitably placed at the predetermined location. In comparison with a case in which a plurality of spacers is individually placed in each predetermined location, the positioning of the spacer 50 can be facilitated.

Note that in the case of a spacer that has either one of the extended portions 52 or 53 not extended beyond the reference line 48, or in the case of the spacer that has no extended portions 53, a portion of the spacer is located at least either one of the portion of the double pipe 40 compressed maximally or the portion thereof drawn maximally. Hence, when the double pipe 40 is bent, the internal pipe 41 can be bent along the spacer. This enables the double pipe 40 to be precisely bent.

Note that like the first preferable embodiment, the singular pipe 13 (see FIG. 1A) through which the second fluid with a higher temperature than that of the first fluid can flow can be caused to abut the outer circumference 43 of the external pipe 42. The elongated portion 51 is continuously provided from the first end 40a of the double pipe 40 to the second end 40b thereof. Accordingly, in comparison with a case in which the singular pipe 13 is placed on the extended portions 52 and 53 that are placed intermittently, the heat transfer efficiency is improved.

### Third Preferable Embodiment

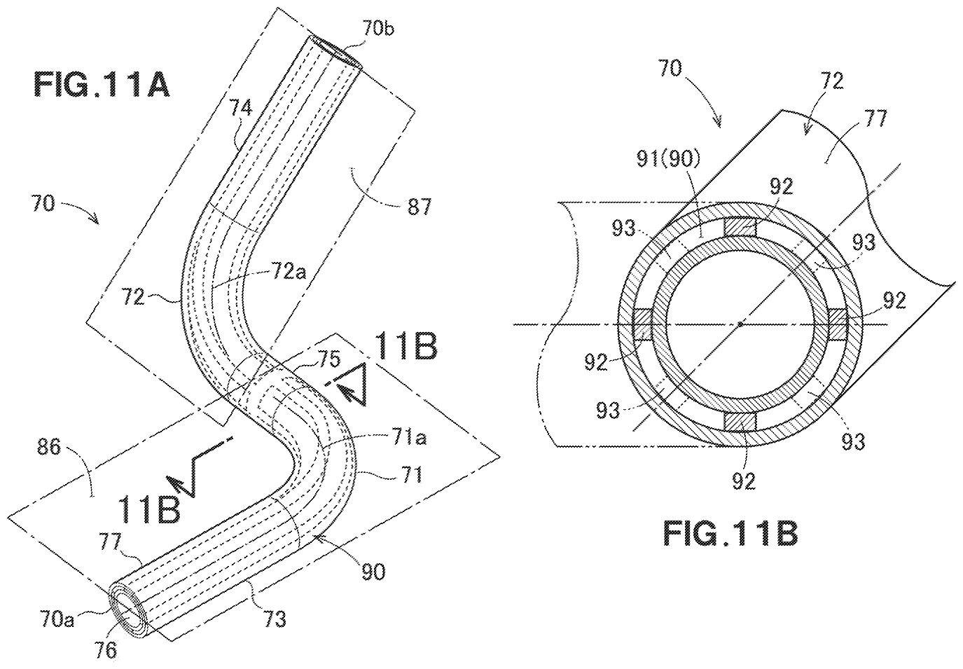

FIG. 11A illustrates a double pipe 70 that includes a plurality of bent portions, e.g., two bent portions 71 and 72. The double pipe 70 includes a first straight pipe portion 73 at a first-end-70a side, a first bent portion 71 provided continuously from and next to the first straight pipe portion 73, a second straight pipe portion 74 at a second-end-70b side, a second bent portion 72 provided continuously from and next to the second straight pipe portion 74, and a third straight pipe portion 75 between the first bent portion 71 and the second bent portion 72. The double pipe 70 includes an internal pipe 76, an external pipe 77, and a spacer 90.

A center line 71a of the first bent portion 71 and a center line 72a of the second bent portion 72 are not located on the same plane. That is, the double pipe 70 is three-dimensionally bent.

A manufacturing method of the double pipe 70 that is three-dimensionally bent will be described.

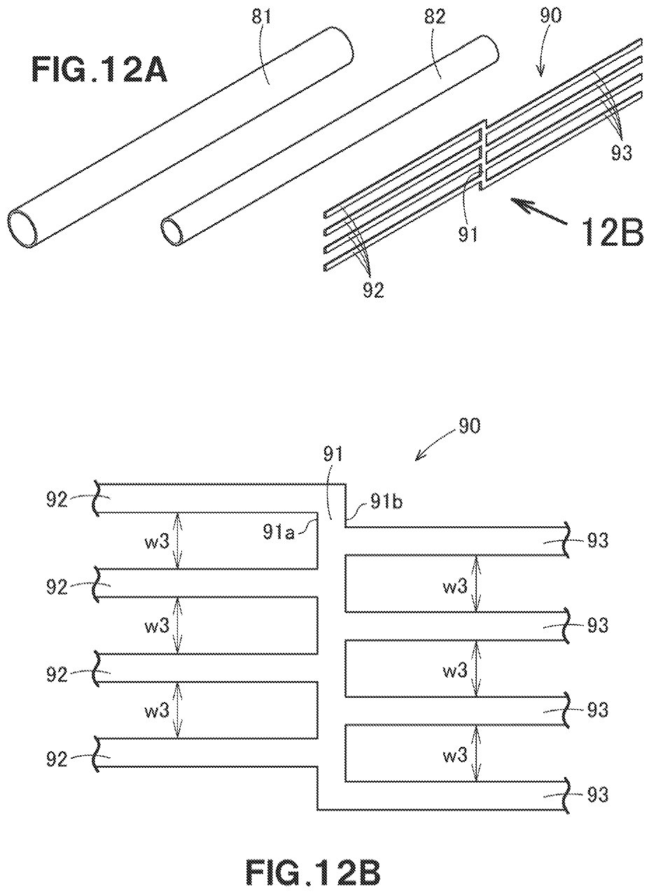

With reference to FIG. 12A, first, a first pipe 81 elongated straightly, a second pipe 82 which is elongated straightly and which can be inserted in the first pipe 81, and a spacer 90 which can be placed between the first pipe 81 and the second pipe 82 are prepared (a preparation step).

With reference to FIG. 12A and FIG. 12B, the spacer 90 includes a base 91 that can be placed along the outer circumference of the second pipe 82, four first elongated portion 92 elongated horizontally from one side face 91a of the base 91, and four second elongated portion 93 elongated horizontally from another side face 91b of the base 91, and those are formed integrally as a singular component.

The base 91 is extended in a lengthwise direction that is orthogonal to the elongated portions 91 and 92. Note that the base 91 may be extend not only in the orthogonal direction but in an oblique direction relative to the elongated portions 91 and 92.

A pitch W3 of the first elongated portions 92 adjacent to each other is uniform. A pitch W3 of the second elongated portions 93 adjacent to each other is also uniform. All the second elongated portions 93 are offset relative to all the first elongated portions 92 in the lengthwise direction of the base 91 (the circumferential direction of the double pipe 70, see FIG. 11A). Note that the respective pitches W3 may differ from each other.

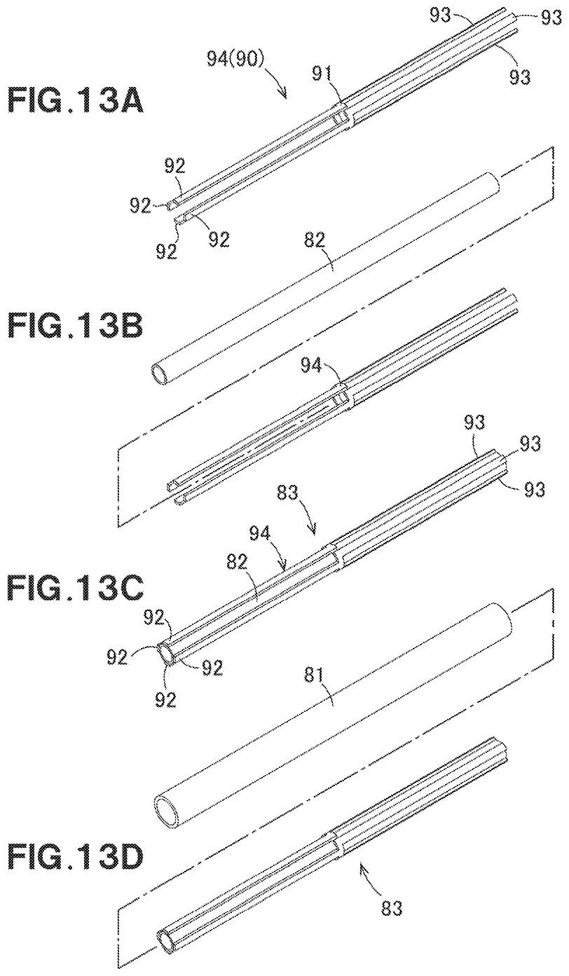

With reference to FIG. 13A, next, the base 91 is bent. More specifically, the base 91 is bent and curved in an annular shape in such a way that the first end of the base 91 in the lengthwise direction and the second end thereof face with each other. Hence, an annular spacer 94 is obtained (a spacer bending step). Note that although the respective ends of the base 91 bent in an annular shape are separated from each other, those may abut with each other.

With reference to FIG. 13B and FIG. 13C, subsequently, the second pipe 82 is inserted in the annular spacer 94, and tentatively fastened to obtain a pipe 83 with the spacer.

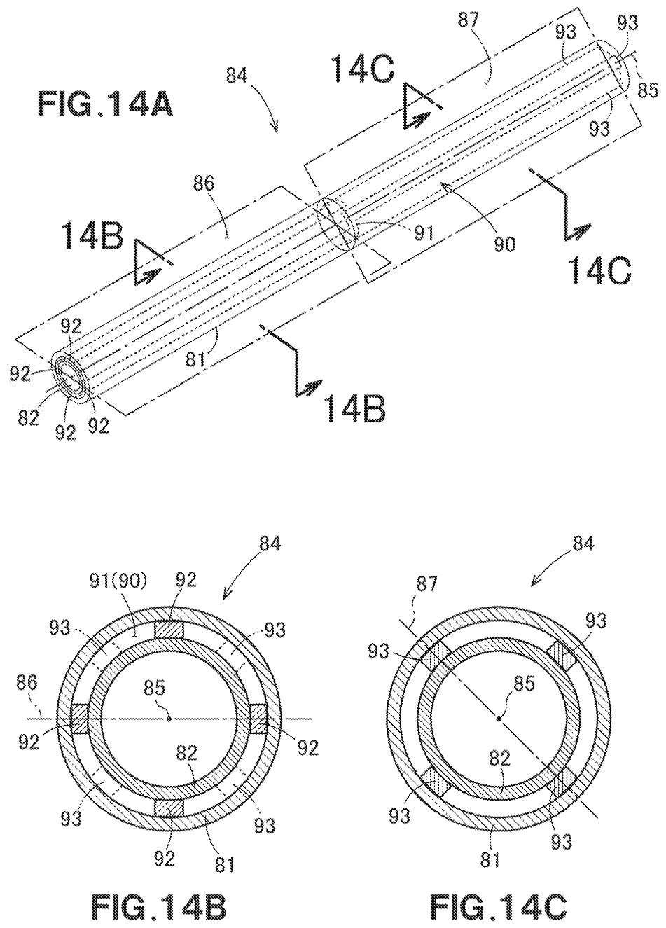

With reference to FIG. 13D and FIG. 14A, next, the pipe 83 with the spacer is inserted in the first pipe 81 to obtain a double straight pipe 84 (a placing step). Note that after the second pipe 82 is inserted in the first pipe 81, the annular spacer 94 may be placed between the first pipe 81 and the second pipe 82.

With reference to FIG. 14A and FIG. 14B, a plane which covers a center line 85 of the double straight pipe 84 and on which the first elongated portions 92 at both sides of the center line 85 overlap will be defined as a first reference surface 86. Next, the double straight pipe 84 is bent along the first reference surface 86. Accordingly, the first bent portion 71 (see FIG. 11A) is formed.

With reference to FIG. 14A and FIG. 14C, a plane which covers the center line 85 of the double straight pipe 84 and on which the second elongated portions 93 at both sides of the center line will be defined as a second reference surface 87. Next, the double straight pipe 84 is bent along the second reference surface 87. Accordingly, the second bent portion 72 (see FIG. 11A) is formed. Through the above steps, the double pipe 70 that includes the two bent portions 71 and 72 is obtained.

With reference to FIG. 11A and FIG. 11B, the base 91 is placed on the third straight pipe portion 75 in the double pipe 70. The first elongated portions 92 are respectively placed at an equal pitch in the circumferential direction. The second elongated portions 93 are respectively placed at an equal pitch in the circumferential direction. All the second elongated portions 93 are located at different locations from those of all the first elongated portions 92 in the circumferential direction. Note that equal to or greater than three bent portions may be formed.

Advantageous effects of the third preferable embodiment will be described below.

With reference to FIG. 12A and FIG. 12B, the four first elongated portions 92, the four second elongated portions 93, and the bases 91 are formed integrally as a singular component. All the second elongated portions 93 are offset in the lengthwise direction of the base 91 relative to all the first elongated portions 92. Adjustment of the offset amount enables an adjustment of the locations of the second elongated portions 93 in the double pipe 70 (see FIG. 11B) and in the circumferential direction.

With reference to FIG. 11A and FIG. 14A, when the double pipe 70 is three-dimensionally bent, the first elongated portions 92 can be placed on the first reference surface 86 of the first bent portion 71, and the second elongated portions 93 can be placed on the second reference surface 87 of the second bent portion 72. The spacer 92 can be placed on the portion of the first bent portion 71 compressed maximally and the portion thereof drawn maximally. Likewise, the spacer 93 can be placed on the portion of the second bent portion 72 compressed maximally and the portion thereof drawn maximally. Note that the one first elongated portion 92 among the four such portions may overlap a plane that covers the center line 71a, and the other three such portions 92 may be located at arbitrary locations in the circumferential direction. Hence, the one first elongated portion 92 is to be placed at either one of the portion to be compressed maximally, or the portion to be drawn maximally. The same is true of the second elongated portions 93. The detailed description will be omitted.

Note that the first preferable embodiment to the third preferable embodiment can be combined as appropriate. For example, the two spacers 90 according to the second preferable embodiment may be prepared, and those may be connected to the base 91 according to the third preferable embodiment to obtain a single spacer. In the third preferable embodiment, the singular pipe 13 according to the first preferable embodiment may be placed along the double pipe 70.

The present disclosure is not limited to the above-described first to third preferable embodiments as long as the advantageous effects of the present disclosure are achievable.

What is claimed is:

1. A double pipe with a bent portion, the double pipe comprising an internal pipe and an external pipe,
wherein at least two spacers in an elongated shape are provided between the internal pipe and the external pipe along a center line of the double pipe,
wherein, in a cross section of the bent portion as viewed in a direction along the center line of the double pipe, the first spacer in at least the two spacers is located inwardly relative to a center of the double pipe and the second spacer is located outwardly relative to the center of the double pipe with reference to a radial direction of the bent portion, and
wherein, with a straight line that passes through a center of a radius of the bent portion and through the center of the double pipe being defined as a reference line, at least either one of the first spacer or the second spacer overlaps the reference line.

2. The double pipe according to claim 1, wherein a heat transfer pipe through which a fluid with a different temperature than a temperature of a fluid flowing through the internal pipe flows abuts an outer circumference of the external pipe.

3. The double pipe according to claim 2, wherein the heat transfer pipe is placed so as to hold the external pipe with either one of at least the two spacers.

4. A manufacturing method of a double pipe comprising:
a preparation step of preparing a first pipe, a second pipe to be inserted in the first pipe, and at least two spacers in an elongated shape to be placed between the first pipe and the second pipe;
a placing step of placing the second pipe and at least the two spacers in the first pipe in such a way that either one of at least the two spacers overlaps a reference surface covering a center line of the second pipe to obtain a double straight pipe; and
a bending step of bending the double straight pipe along the reference surface.

5. A double pipe with a bent portion, the double pipe comprising an internal pipe and an external pipe,
wherein a spacer that comprises an elongated portion in an elongated shape and placed along a center line of the double pipe is provided between the internal pipe and the external pipe, the spacer comprising a plurality of extended portions extended from the elongated portion in a circumferential direction of the double pipe, and
wherein, with a straight line passing through the elongated portion and through a center of the double pipe being defined as a reference line, the respective extended portions are extended beyond the reference line when a cross section of the bent portion is viewed in a direction along the center line.

6. The double pipe according to claim 5, wherein a heat transfer pipe through which a fluid with a different temperature than a temperature of a fluid flowing through the internal pipe flows abuts an outer circumference of the external pipe.

7. The double pipe according to claim 6, wherein the heat transfer pipe is placed so as to hold the external pipe with the elongated portion.

8. A manufacturing method of a double pipe comprising:
a preparation step of preparing a first pipe, a second pipe to be inserted in the first pipe, and a spacer that comprises an elongated portion in an elongated shape, and a plurality of extended portions extended horizontally from a side face of the elongated portion in a lengthwise direction;
a spacer bending step of curving each of the plurality of extended portions of the spacer to obtain a curved spacer;
a placing step of placing the second pipe and the curved spacer in the first pipe with the elongated portion of the curved spacer being aligned with a center line of the second pipe to obtain a double straight pipe that has each of the plurality of extended portions extended beyond a reference line as viewed in a direction along the center line, the reference line being a straight line passing through the elongated portion and a center of the second pipe; and
a straight pipe bending step of bending the double straight pipe.
